(19) United States
(12) Patent Application Publication
(10) Pub. No.: US 2026/0308713 A1
(43) Pub. Date: Oct. 8, 2026

(54) PROCESS FOR RECOVERING PLATINUM-GROUP METAL FROM WASTE CATALYST BY USING BIOCYANIDE AND IONIC LIQUID

(71) Applicant: IUCF-HYU (INDUSTRY- UNIVERSITY COOPERATION FOUNDATION HANYANG UNIVERSITY), Seoul (KR)

(72) Inventors: Hyun Jung KIM, Seoul (KR); Ilyas SADIA, Seoul (KR)

(73) Assignee: IUCF-HYU (INDUSTRY- UNIVERSITY COOPERATION FOUNDATION HANYANG UNIVERSITY), Seoul (KR)

(21) Appl. No.: 19/108,312

(22) PCT Filed: Aug. 17, 2023
(86) PCT No.: PCT/KR2023/012145

§ 371 Date: Mar. 3, 2025

(30) Foreign Application Priority Data
Sep. 14, 2022 (KR) 10-2022-0115296

(51) Int. Cl. C22B 11/08; C01C 3/02; C22B 3/18; C22B 3/38; C22B 11/00

(52) U.S. Cl. CPC C22B 11/08; C01C 3/02; C22B 3/18; C22B 3/38; C22B 11/048

(57) ABSTRACT

Disclosed in the content of the present disclosure is a process for bioleaching platinum group metals contained in spent catalysts using bio-cyanide produced from a microorganism, followed by recovering the platinum group metals with high purity using an organophosphorus ionic liquid as an extractant.

### TECHNICAL FIELD

The present disclosure relates to a process for recovering platinum group metals (PGMs) from spent catalysts using bio-cyanide and ionic liquid. More specifically, the present disclosure relates to a process for bioleaching platinum group metals contained in spent catalysts using bio-cyanide produced from a microorganism, followed by recovering the platinum group metals with high purity using an organophosphorus ionic liquid as an extractant.

### BACKGROUND ART

Due to the recent strengthening of regulations on pollutant gases, catalytic converters are being used mandatorily to treat exhaust gases emitted from various vehicles. To capture exhaust gases, precious metals, for example platinum (Pt), palladium (Pd), etc., are being used as catalytic components.

Traditionally, spent catalytic converters are treated by a dry smelting process, in which precious metals are collected in alloy form using collector metals or capture metals such as Cu⁰ and Fe⁰. However, these processes do not fall within direct extraction. They are also energy-intensive, involve subsequent chemical leaching (or dissolution) to separate relatively low-weight precious metals, and produce large amounts of secondary waste in the form of slag. The slag produced in this way is highly alkaline and is therefore not suitable for landfilling. In addition, the emission of large amounts of carbon dioxide has been problematic. Furthermore, after the alloy is reprocessed and separated from the collector metals, it should be treated as an individual precious metal salt. Moreover, in the dry smelting process, the platinum recovery rate is about 80 to 94%, and the palladium recovery rate is about 80 to 96%. Hence, the cost associated with the entire recycling process is significantly increased.

Alternatively, hydrometallurgical methods have been proposed, but they use highly concentrated toxic acids, releasing hazardous wastewater and gaseous pollutants that increase environmental stress. In addition, since they involve wastewater treatment as a post-treatment step, the cost required therefor is high, and gas cleaning also requires the use of expensive and sophisticated equipment, which inevitably increases the overall treatment cost.

In this regard, chemical cyanidation processes have been devised as a potential alternative to limit the use of highly concentrated acids. However, toxicity of free cyanide makes transportation hazardous and the cost of decomposing cyanide before discharging cyanide-containing wastewater is high.

Recently, as an a alternative to inorganic metal extraction involving solution chemistry, environmentally friendly microbial-based technology, particularly technology for leaching and recovering platinum group metals from spent catalysts using a bio-cyanide solution produced from cyanide-producing bacteria, has been reported (Korean Patent No. 1575582; Hydrometallurgy 158 (2015) 10-18).

However, the bioleaching-based technology described above does not specifically mention how to recover platinum group metals from cyanide leach liquor. In order to separate and recover platinum group metals from the leach liquor containing platinum group metals, a precipitation method by addition of an ion exchange resin and a sulfide such as sodium sulfide (NaHS) is also known (e.g., U.S. Pat. No. 7,544,231). However, it is very costly to decompose cyanide remaining in the solution, and it is not easy to discharge, especially due to toxicity.

### DISCLOSURE

### Technical Problem

An embodiment of the present disclosure provides an environmentally friendly method capable of inexpensively and effectively recovering platinum group metals (PGMs) while minimizing the use of toxic substances compared to conventional techniques, in order to recover platinum group metals from spent catalysts containing platinum group metals.

Another embodiment of the present disclosure provides a method of recycling residue generated after recovering platinum group metals from spent catalysts using a microorganism.

### Technical Solution

An embodiment of the present disclosure provides a method of recovering platinum group metals from a spent catalyst, comprising:
a) forming a platinum group metal-containing cyanide leach liquor by leaching platinum group metals from a platinum group metal-containing spent catalyst using a solution containing bio-cyanide produced by metabolic action of a cyanide-producing microorganism;
b) forming a platinum group metal-rich extract and a platinum group metal-depleted raffinate by liquid-liquid extraction treatment of the platinum group metal-containing cyanide leach liquor using a water immiscible organophosphorus ionic liquid as an extractant; and
c) recovering platinum group metals from the extract.

According to an embodiment, the platinum group metal-containing spent catalyst may contain at least one platinum group metal selected from the group consisting of platinum and palladium.

According to an embodiment, the platinum group metal-containing spent catalyst may not contain rhodium.

According to an embodiment, the platinum group metal-containing spent catalyst may be provided in step a) in the f form of particles or ground material having a particle size of 350 μm or less.

According to an embodiment, a total content of platinum group metals in the platinum group metal-containing spent catalyst may be in the range of 0.005 to 0.4 wt %.

According to an embodiment, the platinum group metal-containing spent catalyst contains platinum and palladium, and respective contents of platinum and palladium may be 0.003 to 0.15 wt % and 0.002 to 0.1 wt %.

According to an embodiment, the pH of an aqueous solution containing bio-cyanide in step a) may be in the range of 9.5 to 14, and the concentration of cyanide (CN⁻) may be in the range of 2 to 6 g/L.

According to an embodiment, the method may further comprise concentrating or accumulating the solution containing bio-cyanide by being trapped or collected into an alkali solution, before leaching the platinum group metals in step a).

According to an embodiment, the pH of the platinum group metal-containing cyanide leach liquor formed in step a) may be in the range of 9 to 12.5.

According to an embodiment, the organophosphorus ionic liquid used in step b) may comprise a phosphonium-based cation group represented by General Formula 1 below, and an anion group selected from the group consisting of a halide, a sulfide, and a nitrate:

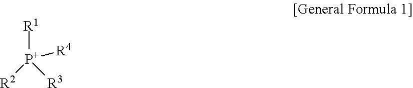

wherein R¹ to R⁴ are each an alkyl group having 35 to 56 carbon atoms.

According to an embodiment, the molecular weight (M_{w}) of the organophosphorus ionic liquid used in step b) may be in the range of 200 to 900.

According to an embodiment, step c) may be performed by stripping.

According to an embodiment, the method may further comprise separating the organophosphorus ionic liquid from the extract remaining after recovery of the platinum group metals in step c) and reusing the same as an extractant in step b).

### Advantageous Effects

According to embodiments of the present disclosure, a process for recovering platinum group metals from spent catalysts is capable of dramatically solving problems (for example, emission of harmful gases or toxic substances, generation of slag, high energy requirements, etc.) pointed out in conventional techniques (dry smelting process, acid-based chemical hydrometallurgical process, etc.) by use of a green biogenic cyanide solution based on bioleaching or bio-hydrometallurgical mechanisms. Moreover, by performing a liquid-liquid extraction method using a particular extractant, platinum group metals can be easily separated from a platinum group metal-containing leach liquor produced by bio-cyanide-based leaching, and also, individual platinum group metals can be recovered with high purity. In particular, since it is environmentally friendly, low energy-intensive, and highly efficient, the present disclosure is also in line with ESG strategies of related companies, so widespread commercialization is expected in the future.

### DESCRIPTION OF DRAWINGS

FIG. 1 is a flowchart schematically showing a process for recovering platinum group metals from a spent catalyst;

FIG. 2 shows a process for recovering platinum group metals from a spent catalyst;

FIG. 3 shows an example of an apparatus for conducting a cyanide production experiment using bacteria;

FIG. 4 is a graph showing results of measurement of the C. violaceum cell count in YP medium supplemented with 2.0 g/L glycine over time in batch mode bio-cyanide production;

FIG. 5 is graphs showing accumulation of biogenic cyanide and a change in pH over time when preparing a bio-cyanide solution using YP medium with a glycine concentration of 2.0 g/L and a 4.0 mol/L NaOH trapping solution in (a) a batch mode and (b) a continuous mode, respectively;

FIG. 6 is a graph showing the effect of temperature on the pressurized bio-cyanidation reaction of Pt and Pd from a spent catalytic converter under conditions of CN⁻ concentration of 2.9 g/L, pO₂ of 10.5 bar, initial pH of 11.2, and 60 minutes;

FIG. 7 is a graph showing the effect of partial oxygen pressure (pO₂) on the pressurized bio-cyanidation reaction of Pt and Pd from a spent catalytic converter under conditions of temperature of 150° C., CN⁻ concentration of 2.9 g/L, initial pH of 11.2, and 60 minutes;

FIG. 8 is a graph showing the effect of the bio-cyanide concentration on the pressurized bio-cyanidation reaction of Pt and Pd from a spent catalytic converter under conditions of temperature of 150° C., pO₂ of 14 bar, initial pH of 11.2, and 60 minutes;

FIG. 9 is (a) a graph showing the effect of the concentration of an ionic liquid on extraction of Pt and Pd from a cyanide leach liquor under given conditions (O:A, 1; pH, 10.8; contact time, 10 minutes; and temperature, 25° C.), and shows (b) a log plot of D vs. P-IL;

FIG. 10 is a graph showing the effect of pH of a platinum group metal-containing solution (leach liquor) on Pt—Pd extraction under given conditions (O:A, 1; P-IL concentration, 0.15 mol/L; contact time, 10 minutes; and temperature, 25° C.);

FIG. 11 is (a) a graph showing the effect of the temperature on Pt—Pd extraction under given conditions (O:A, 1; P-IL concentration, 0.15 mol/L; solution pH, 10.4; and contact time, 10 minutes), and shows (b) a Van′t Hoff plot for log Kₑₓ VS. 1/T;

FIG. 12 is a graph showing the effect of the concentration of NH₄SCN on stripping behavior of Pt and Pd in an ionic liquid phase under given conditions (O:A, 1; contact time, 10 minutes; and temperature, 25° C.);

FIG. 13 is a graph showing the effect of the concentration of S(CH₂CH₂OH)₂ on Pt stripping in a Pd-depleted ionic liquid phase under given conditions (O:A, 1; contact time, 10 minutes; and temperature, 25° C.);

FIG. 14 is graphs showing (a) behavior of leaching Pt and Pd from a spent catalytic converter using a bio-cyanide solution accumulated in a raffinate recycled after performing a (Pt, Pd) extraction process using P-IL, and (b) results of evaluating reusability of the ionic liquid in a (Pt, Pd) extraction cycle from a cyanide leaching solution; and

FIG. 15 is a graph showing experimental results of biodegrading cyanide in a bleed solution using C. violaceum, which was used to produce bio-cyanide and then drained from a bioreactor.

### BEST MODE

The present disclosure may be realized in its entirety based on the following description. It should be understood that the following description is given of preferred embodiments of the present disclosure, and the present disclosure is not necessarily limited thereto. In addition, the accompanying drawings are provided to aid understanding of the present disclosure, and the present disclosure is not limited thereto, and details regarding individual components may be appropriately understood by the specific intent of the related description described below.

Terms used herein may be defined as follows.

“Platinum group metal” may be understood to broadly include six metallic elements belonging to the platinum group, for example platinum, palladium, rhodium, ruthenium, iridium, and osmium, and may be understood to refer to platinum and/or palladium in a narrow sense.

“Bioleaching” may generally mean a process of dissolution of a metal from a mineral source by a microorganism, for example a process of converting a solid metal into a water-soluble form.

“Culture medium” may mean an aqueous solution of nutrients useful for cell growth.

“Extraction” may mean the transfer of a specific component, for example a metal, from one phase to another.

“Stripping” may mean a process of separating or removing a specific metal from a liquid medium or solvent, and selective stripping may be a process of separating or removing a specific metal from a liquid medium or solvent containing multiple metals.

Herein, when a numerical range is specified as a lower limit and/or an upper limit, it may be understood that any sub-combination within the numerical range is also disclosed. For example, when described as “1 to 5”, it may include not only 1, 2, 3, 4, and 5, but also any sub-combinations thereof.

When any component or member is described herein as being “connected” to another component or member, it may be understood that it includes not only cases where it is directly connected to the other component or member, but also cases where it is connected via a further component or member interposed therebetween, unless stated otherwise.

Similarly, the term “contact” may be understood to include not only direct contact, but also contact by the intervention of a further component or member.

When any component is “included,” it means that another component may be further included, unless specified otherwise.

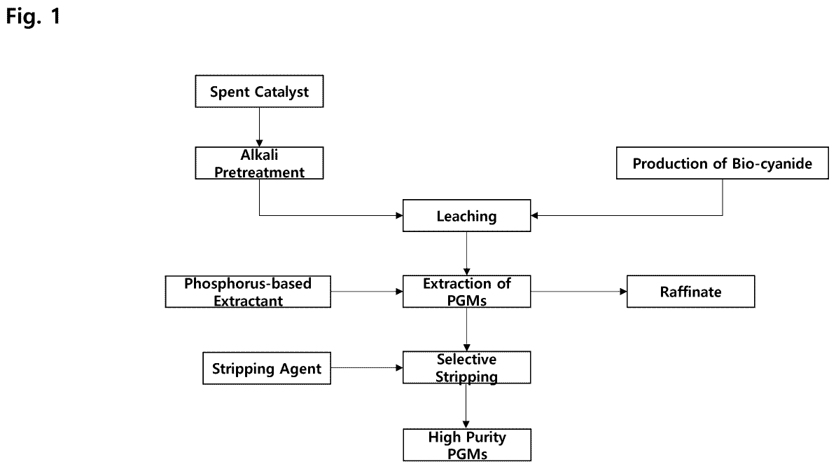

According to an embodiment of the present disclosure, bioleaching and solvo-chemical extraction processes using a microorganism are provided to separate and recover platinum group metals from a spent catalyst containing platinum group metals, which is schematically shown in FIG. 1.

Referring to this figure, a solid platinum group metal-containing spent catalyst may be used as a starting material. In this regard, platinum group metal-containing spent catalysts may be obtained from various fields such as automobile and chemical industries, and may typically be derived from catalytic converters (e.g., catalytic converters of automobiles).

According to an embodiment, the platinum group metal content in the spent catalyst is not particularly limited, but the platinum group metal content (on an elemental basis) in the spent catalyst may be, for example, about 0.005 to 0.4 wt %, for example about 0.01 to 0.3 wt %, for example about 0.011 to 0.15 wt %.

In an embodiment, the spent catalyst may contain platinum and/or palladium among platinum group metals. According to a specific embodiment, the spent catalyst may contain both platinum and palladium, in which the content of platinum (Pt) (on an elemental basis) may be, for example, about 0.003 to 0.15 wt %, for example about 0.005 to 0.1 wt %, for example about 0.08 wt %, and also, the content of palladium (Pd) (on an elemental basis) may be, for example, about 0.002 to 0.1 wt %, for example about 0.004 to 0.05 wt %, for example about 0.04 wt %. For example, a platinum/palladium weight ratio may be in the range of about 0.1 to 3, for example about 0.3 to 2.5, for example about 0.5 to 2.1.

According to an embodiment, the spent catalyst may further contain other components, such as alumina, magnesia, silica, zirconia, titania, calcium oxide, etc., in addition to the platinum group metal, and the content of the component or metal that may be further contained (on an elemental basis) may be, for example, in the range of about 60 wt % or less, for example about 40 wt % or less, for example about 20 wt % or less.

Meanwhile, the spent catalyst may be substantially free of rhodium. Thus, platinum group metal-containing catalysts that do not contain rhodium may be typically obtained from old generation catalysts of automobile vehicles, for example second generation catalysts of automobile vehicles, and the compositional characteristics thereof may affect the process of extracting Pt and Pd using ionic liquid, the process of reusing the cyanide leach liquor remaining after use, and the process of biodegrading cyanide remaining in the solution discharged in a certain amount before reuse of the cyanide leach liquor. However, the presence of a trace amount of rhodium in the form of impurities, etc. may not be excluded, and for example, rhodium may be contained at less than about 0.0004 wt %, for example less than about 0.0001 wt %. However, since rhodium may act as an impurity during extraction of Pt and Pd to thus lower the purity of Pt and Pd to be recovered, and also since rhodium may accumulate in the solution due to repetition of the process of recycling the raffinate generated during extraction, it may be advantageous to contain as little rhodium as possible. The platinum group component content in the spent catalyst described above may be understood as illustrative, and may vary depending on the source.

According to an embodiment, the spent catalyst may be provided in the form of particles or ground material. Here, the particle size or diameter of the ground material or particles may be determined in consideration of effective contact with the bio-cyanide solution described below, flow characteristics within the reactor, etc., and may be adjusted in the range of, for example, about 350 μm or less, for example about 250 μm or less, for example about 100 to 200 μm, for example about 120 to 180 μm. Meanwhile, the spent catalyst derived from exhausted catalytic converters for automobiles may be provided in a ground form after separation of the catalyst layer. As such, for grinding, any means known in the art may be used. Examples of the grinding means may include, but are not limited to, a roller grinder, a vibrating mill, a ball mill, a pot mill, a hammer mill, a pulverizer, a gyratory crusher, a gyratory mill, and the like, and grinding may also be performed by combination of two or more thereof.

### Pretreatment of Spent Catalyst (Optional)

Referring to FIG. 1, the platinum group metal-containing spent catalyst may be optionally subjected to alkali pretreatment. Such alkali pretreatment may be performed to remove carbonaceous substances from the spent catalyst (or spent catalyst particles) and various impurities that may inhibit subsequent bio-cyanidation. For example, alkali treatment may be performed by bringing the spent catalyst into contact an alkali-containing solution (e.g., aqueous solution). Here, the alkali component may be at least one selected from among sodium hydroxide, potassium hydroxide, ammonium hydroxide, and the like. Also, the concentration of the alkali solution may be adjusted in the range of, for example, about 1 to 5 mol/L, for example about 1.5 to 4 mol/L, for example about 2 to 3 mol/L. Also, the pretreatment temperature may be adjusted in the range of, for example, at least about 60° C., for example about 70 to 98° C., for example about 80 to 95° C. In addition, the pretreatment time is not particularly limited, but may be adjusted in the range of, for example, about 30 to 200 minutes, for example about 40 to 100 minutes, for example about 50 to 80 minutes.

### Production of Bio-Cyanide

According to an embodiment, synthesizing cyanide, for example bio-cyanide (HCN), is performed by growth and culture of a cyanide-producing microorganism separately from the supply of the spent catalyst described above, whereby a solution (e.g., an aqueous solution) containing bio-cyanide may be formed.

In this regard, the microorganism may be selected from among classes capable of producing cyanide by metabolic action. For example, the cyanide-producing microorganism may be at least one selected from among classes belonging to betaproteobacteria, gammaproteobacteria, and the like, and may be at least one selected from among, for example, Chromobacterium violaceum, Pseudomonas fluorescens, Pseudomonas plecoglossicida, Bacillus megaterium, and the like. In particular, the cyanide-producing microorganism may be a class capable of producing cyanide by oxidative decarboxylation reaction of glycine. According to a specific embodiment, Chromobacterium violaceum, which is a gram-negative betaproteobacterium as a spoilage bacterium and catalyzes oxidase reaction, may be used. However, the microbial classes listed above may be understood as illustrative.

According to an embodiment, for culturing the cyanide-producing microorganism, growth medium, for example YP medium supplemented with glycine, may be used. As such, the concentration of glycine in the medium may be in the range of, for example, about 0.5 to 5 g/L, for example about 1.5 to 3.5 g/L, for example about 2 to 2.5 g/L. Since the ingredients of the medium for microbial growth in this embodiment are known in the art, any detailed descriptions thereof will be omitted.

By way of an example, the pH of the growth medium may be adjusted considering the microbial characteristics, in the range of, for example at least about 7, for example about 8 to 9, for example about 8.5. Also, the culture temperature is not particularly limited, but may typically be adjusted in the range of about 20 to 40° C., for example about 25 to 35° C.

Also, the concentration of the microorganism in the initial growth medium may be in the range of, for example, at least about 10⁵ CFU/ml, for example about 10⁶ to 10⁹ CFU/ml, for example about 10⁷ to 10⁸ CFU/ml, which may be understood as illustrative.

According to an embodiment, culture of the microorganism may be performed under supply of oxygen-containing gas, for example, air, and for example, culture may be performed using a bioreactor equipped with an aerator. The concentration of cyanide after culture may be in the range of, for example, about 900 to 1,200 mg/L, for example about 950 to 1,100 mg/L, for example about 1,000 to 1,100 mg/L.

According to an embodiment, a concentration or accumulation step may be performed to increase the concentration of bio-cyanide produced by microbial culture. To this end, an alkali solution (e.g., aqueous solution) may be used, so the produced cyanide (HCN) may be trapped or collected into the alkali solution.

For example, the alkali ingredient in the alkali solution (trapping or collecting solution) may be at least one selected from among sodium hydroxide, potassium hydroxide, ammonium hydroxide, and the like, and the concentration thereof may be adjusted in the range of, for example, about 1 to 8 mol/L, for example about 1.5 to 6 mol/L, for example about 3 to 5 mol/L, which may be understood as illustrative. The principle of cyanide trapping is based on a phenomenon that the vapor density of cyanide (HCN) (0.94) is lower than the vapor density of air (1.0), and for this purpose, it is desirable to push HCN toward the alkali solution by aeration as much as possible. For example, cyanide trapping may be performed according to Scheme 1 below.

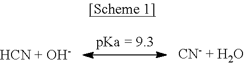

For example, the trapping time may be appropriately adjusted in the range of, for example, about 20 to 120 hours, for example about 40 to 110 hours, for example about 60 to 105 hours, for example about 90 to 100 hours, taking into account the desired concentration of bio-cyanide.

As described above, the concentration of cyanide or cyanide ion (i.e., CN⁻) concentrated or accumulated in the alkali solution may be increased to, for example, about 2 to 6 g/L, for example about 3 to 5 g/L, for example about 4 to 4.5 g/L. In this regard, if the concentration of cyanide is less than a certain level, there is a limit to increasing leaching efficiency during subsequent bioleaching, whereas if it exceeds a certain level, the leaching efficiency no longer increases, and hence, it may be advantageous to appropriately adjust the extent of concentration thereof.

Also, the pH of the concentrated cyanide solution may be in the range of, for example, about 9.5 to 14, for example about 10 to 12, for example about 10.5 to 11.5.

Meanwhile, according to an embodiment, the production of bio-cyanide and the concentration or accumulation of cyanide using an alkali solution (trapping solution or alkali collector) may be performed in a batch or continuous mode, but considering that bio-cyanide is produced in a relatively short time, a continuous mode may be advantageous.

### Bioleaching Using Cyanide

According to an embodiment of the present disclosure, leaching of platinum group metals in a platinum group metal-containing spent catalyst is performed by supplying the obtained bio-cyanide-containing solution or the concentrated (accumulated) bio-cyanide-containing solution as a lixiviant medium. As such, the platinum group metal in the spent catalyst may be provided in the form of, for example, a complex by coupling with cyanide ion.

According to an embodiment, the amount of the spent catalyst in the bio-cyanide-containing solution for concentrated for accumulated) bio-cyanide-containing solution) may be adjusted in the range of, for example, about 2 to 40 g/100 ml, for example about 5 to 25 g/100 ml, for example about 10 to 20 g/100 ml. As such, the bioleaching process may be performed under stirring conditions, and the stirring speed may be adjusted in the range of, for example, about 100 to 400 rpm, for example about 200 to 250 rpm, which may be understood as illustrative.

Also, the leaching time may be determined in consideration of maximum leaching of Pt and Pd, for example, in the range of about 30 to 360 minutes, for example about 30 to 120 minutes, for example about 60 to 90 minutes.

Meanwhile, according to an embodiment, bioleaching may be set under conditions of elevated temperature and increased oxygen pressure (pO₂). In this regard, the leaching temperature may be adjusted in the range of, for example, about 100 to 200° C., for example about 120 to 180° C., for example about 140 to 160° C. As such, the leaching temperature that is excessively low or high may act as a factor that reduces the leaching efficiency, and hence, it may be advantageous to appropriately adjust the leaching temperature within the aforementioned range. However, the leaching temperature may vary depending on the other conditions, such as the concentration of cyanide, leaching time, oxygen pressure, etc.

In addition, according to an embodiment, the leaching efficiency may tend to increase with an increase in the pressure, for example the oxygen pressure (or partial oxygen pressure), during bioleaching. For example, the oxygen pressure may be adjusted in the range of at least about 8 bar, for example about 10 to 18 bar, for example about 12 to 16 bar. However, excessively high oxygen pressure (or partial pressure) results in only a small increase in leaching efficiency, and rather, it may reduce the economic feasibility of the process, so it may be advantageous to appropriately control the oxygen pressure within the aforementioned range.

By the bioleaching process described above, most of the platinum group metals in the spent catalyst may be leached in a cyanide solution, and the leaching efficiency of the platinum group metal may be, for example, at least about 90%, for example at least about 92%, for example at least about 95%. As such, the cyanide solution in which the platinum group is leached may be alkaline, and the pH of the platinum group metal-containing leach liquor may be in the range of, for example, about 9 to 12.5, for example about 10 to 12, for example about 10.2 to 11.5, for example about 10.5 to 11, which may be understood as illustrative.

### Separation and Recovery of Platinum Group Metals (or Metal)

### Separation (Extraction) of Platinum Group Metals

According to an embodiment of the present disclosure, the platinum group metal-containing cyanide leach liquor produced by bioleaching contains other components (e.g., Al₂O₃, MgO, SiO₂, ZrO₂, Cao, TiO₂, etc.) in addition to the platinum group metals to be recovered, and selectively separating and recovering the platinum group metals using a solvo-chemical process is performed. To this end, in the present embodiment, a platinum group metal-rich extract and a platinum group metal-depleted raffinate may be formed by selectively transferring the platinum group metals from the leach liquor into the extract by liquid-liquid extraction.

According to an embodiment, a water immiscible organophosphorus ionic liquid may be used as an extractant. In this regard, an organophosphorus ionic liquid is environmentally friendly because it is non-flammable, unlike existing extractants, and also has good mass transfer and loading capacity.

According to an embodiment, the phosphorus ionic liquid may contain a phosphonium-based cation group represented by General Formula 1 below:

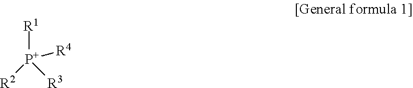

wherein, R¹ to R⁴ are each an alkyl group having 35 to 56 carbon atoms, for example 38 to 50 carbon atoms, for example 40 to 48 carbon atoms.

Meanwhile, the anion constituting the phosphonium-based ionic liquid may be at least one selected from among a halide, a sulfide, a nitrate, and the like. As such, the halide may be at least one selected from among fluoride, chloride, bromide, iodide, and the like, and, for example, may be chloride (Cl⁻).

According to an embodiment, the molecular weight (M_{w}) of the phosphonium-based ionic liquid may be in the range of, for example, about 200 to 900, for example about 300 to 800, for example about 400 to 700. In this regard, considering that the molecular weight of the phosphonium-based ionic liquid affects the extraction efficiency and selectivity for platinum group metals, it may be advantageous to use a type of phosphonium-based ionic liquid having a molecular weight in the aforementioned range. According to a specific embodiment, trihexyl(tetradecyl)phosphonium chloride may be representatively exemplified as the phosphonium-based ionic liquid, which exhibits anion exchange properties and may be advantageous in extracting the platinum group metals contained in the cyanide leach liquor.

According to an embodiment, the organophosphorus ionic liquid may be applied to the extraction process in a form mixed with an aromatic solvent, taking into consideration the dielectric constant of the solvent, metal affinity, and affinity with the ionic liquid and aqueous solution. As the aromatic solvent, aromatic solvents having 7 to 12 carbon atoms, for example 8 to 11 carbon atoms, for example about 10 carbon atoms may be used. Commercially available examples thereof may include Solvesso 100, Solvesso 150, Solvesso 200, Exxsol D80, and the like. Here, the concentration of the organophosphorus extractant may be adjusted in the range of, for example, at least about 0.08 mol/L, for example at least about 0.1 mol/L, for example about 0.12 to 0.3 mol/L, for example about 0.14 to 0.2 mol/L.

As described above, when the phosphonium-based ionic liquid is used as the extractant, an organometallic complex is formed between the cyanide of the platinum group metals (e.g., Pt and/or Pd) and the ionic liquid in the extract. Specifically, it is supposed that the metal moves from the aqueous phase to the organic phase by ion exchange between the anion of the phosphonium-based ionic liquid and the metal ion (e.g., the anion in which platinum and a cyanide group are coupled). For example, when trihexyl(tetradecyl)phosphonium chloride, the phosphonium-based ionic liquid, is used as an extractant, the structure of the organometallic complex resulting from ion exchange reaction may be as represented by Chemical Formula 1 below.

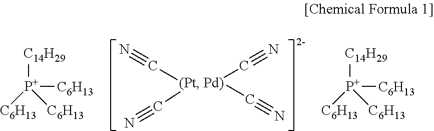

According to an embodiment, the extraction conditions are not particularly limited, but the volume ratio of organic phase to aqueous phase may be adjusted in the range of about 1:5 to 5:1, for example about 1:3 to 3:1, for example about 1:2 to 2:1. Meanwhile, the equilibrium time may be in the range of about 2 to 30 minutes, for example about 5 to 15 minutes, for example about 5 to 10 minutes. In addition, the extraction temperature may be, for example, about 20 to 40° C., for example about 22 to 35° C., for example about 24 to 30° C., for example about 25° C.

Meanwhile, since the platinum group metal-depleted raffinate (aqueous phase) remaining during extraction using the organophosphorus ionic liquid contains cyanide, it may be used to leach the platinum group metals from the spent catalyst. For example, it may be recycled into the solution containing bio-cyanide, and/or the solution containing bio-cyanide concentrated (or accumulated) by an alkali solution (trapping or collecting solution).

Meanwhile, at least a portion of the platinum group metal-depleted raffinate may be treated in a manner that decomposes (e.g., biodegrades) the cyanide contained therein. As such, cyanide may be decomposed by the microorganism that may be used to produce bio-cyanide described above, and after the decomposition process, it may be discharged outside the process or system.

### Recovery of Platinum Group Metals (or Metal)

According to an embodiment of the present disclosure, recovering the platinum group metals from the platinum group metal-rich extract may be performed. As such, the platinum group metals recovered may be a single platinum group metal or a combination of at least two platinum group metals.

Although the present embodiment is not intended to exclude recovery of a combination of two or more platinum group metals, for example, a combination of Pt and Pd, it may be advantageous to recover each platinum group metal contained in the spent catalyst at high purity, considering usability, etc. From this perspective, the following will focus on methods for recovering each of platinum group metals, for example Pt and Pd, from the extract.

According to an embodiment, selective stripping may be performed to recover a plurality of platinum group metals from an extract (i.e., an organophosphorus ionic liquid). For example, when the extracted platinum group metals in the extract (organic phase) are platinum (Pt) and palladium (Pd), Pt and Pd may each be recovered in a manner in which bringing a solution (e.g., an aqueous solution) of a compound (i.e., a stripping agent) exhibiting selectivity for a specific metal into contact with the platinum group metal-containing extract (oil phase) is performed individually or sequentially.

According to an embodiment, first, in order to selectively strip palladium from the extract containing platinum (Pt) and palladium (Pd), an aqueous solution of a stripping agent that is miscible with water and selective for palladium may be used (first stripping step). Such a stripping agent may be selected from among thiol compounds that are selective for forming Pd complexes. For example, the Pd selective stripping agent may be a thiocyanate compound. Such a thiocyanate compound may be at least one selected from among, for example, ammonium thiocyanate (NH₄SCN), sodium thiocyanate (NaSCN), potassium thiocyanate (KSCN), and the like. For example, an ammonium thiocyanate (NH₄SCN) compound may be used.

In this regard, the concentration of the aqueous stripping agent solution selective for palladium may be controlled so that the Pd stripping efficiency is maximized and at the same time the Pt stripping efficiency is minimized, and may be in the range of, for example, at least about 0.7 mol/L, for example at least about 0.8 to 3 mol/L, for example about 1.2 to 2.6 mol/L, for example about 1.8 to 2.3 mol/L.

According to an embodiment, the volume ratio of organic phase to aqueous phase during palladium stripping may be adjusted in the range of about 1:5 to 5:1, for example about 1:3 to 3:1, for example about 1:2 to 2:1. In addition, the stripping temperature may be, for example, about 20 to 40° C., for example about 22 to 35° C., for example about 24 to 30° C., for example about 25° C. In addition, the contact time is not particularly limited, but may be appropriately adjusted in the range of, for example, about 2 to 30 minutes, for example about 5 to 15 minutes, for example about 5 to 10 minutes.

According to an embodiment, the stripping efficiency of palladium may be at least about 90%, for example at least about 95%, for example at least about 98%. In contrast, the stripping efficiency of platinum may be, for example, less than about 3%, for example less than about 2.5%, for example less than about 2%. In this way, selective stripping for palladium enables formation of a palladium-rich fraction and a palladium-depleted fraction.

Next, the organic phase, namely the palladium-depleted fraction in which most of the platinum (Pt) is contained in the organophosphorus ionic liquid, may be additionally stripped to recover platinum (second stripping step).

In this regard, as palladium is separated in advance in the two-component (Pd and Pt) separation step, the platinum stripping agent may be selected from among types that are easy to form a Pt complex and have properties of transferring Pt from an organic phase to an aqueous phase. Such a platinum stripping agent may be, for example, a thioalcohol, for example at least one selected from among 2,2-thiodiethanol (S(CH₂CH₂OH)₂), beta-rhodinol, (S)-3,7-dimethyl-6-often-1-ol, and the like. For example, 2,2-thiodiethanol (S(CH₂CH₂OH) 2) may be used.

In this regard, the concentration of the aqueous platinum selective stripping agent solution is determined in consideration of maximum Pt stripping efficiency, and may be adjusted in the range of, for example, at least about 0.8 mol/L, for example at least about 1 to 3 mol/L, for example about 1.2 to 2.2 mol/L, for example about 1.4 to 2 mol/L.

According to an embodiment, the volume ratio of organic phase to aqueous phase during platinum stripping may be adjusted in the range of about 1:5 to 5:1, for example about 1:3 to 3:1, for example about 1:2 to 2:1. In addition, the stripping temperature may be, for example, about 20 to 40° C., for example about 22 to 35° C., for example about 24 to 30° C., for example about 25° C. In addition, the contact time is not particularly limited, but may be appropriately adjusted in the range of, for example, about 2 to 30 minutes, for example about 5 to 15 minutes, for example about 5 to 10 minutes.

According to an embodiment, the platinum stripping efficiency may be at least about 90%, for example at least about 95%, for example at least about 98%.

Through the sequential stripping process described above, palladium and platinum contained in the extract (organophosphorus ionic liquid) may be individually separated. As such, each stripping solution may be subjected to methods known in the art, such as precipitation and salt formation, thereby individually recovering high-purity platinum group metals, for example platinum and palladium. In order to recover platinum and palladium from a platinum group metal-containing stripping solution, for example a platinum-containing solution and a palladium-containing solution, respectively, a precipitate of a platinum group metal (for example, platinum and palladium) salt (e.g., (NH₄)₂PtCl₆, (NH₄) 2PdCl₆, etc.) may be formed by reaction by adding, for example, an ammonium salt, a sulfide, etc. As such, the concentration of the added component, for example, ammonium ion, may be determined depending on the amount of platinum group metal in the stripping solution, and may be in the range of, for example, about 0.01 to 0.05 mol/L, for example about 0.02 to 0.04 mol/L, for example about 0.02 to 0.03 mol/L. However, the above numerical ranges may be understood as illustrative.

In addition, the temperature conditions during precipitation are not particularly limited, but may be adjusted in the range of, for example, about 20 to 100° C., for example about 30 to 80° C., for example about 40 to 50° C.

Meanwhile, the extract remaining after the stripping process, for example the organophosphorus ionic liquid, may be recycled after the separation process and reused as an extractant in the extraction step before the stripping step. For example, the ionic liquid may be separated by contact with an aqueous solution of at least one selected from among strong acids, such as hydrochloric acid, nitric acid, sulfuric acid, hydrofluoric acid, and the like. As such, the concentration of the aqueous acid solution may be adjusted in the range of, for example, about 3 to 9 mol/L, for example about 4 to 8 mol/L, for example about 5 to 7 mol/L, but may vary depending on the type of acid used.

### MODE FOR INVENTION

The present disclosure may be more clearly understood by the following examples, which are merely set forth to illustrate the present disclosure and are not to be construed as limiting the scope of the present disclosure.

### EXAMPLES

In this example, a vehicle spent catalytic converter (5 kg) obtained from domestic waste disposal companies was used. The collected catalyst was finely ground to a size of about 150 μm using a gyratory crusher and a ball mill.

The composition of the ground spent catalyst was analyzed by X-ray fluorescence (X-ray Fluorescence S4 Pioneer, Bruker, Germany). The amounts (unit: wt %) of major inorganic oxides excluding metal components such as platinum group metals are shown in Table 1 below.

TABLE 1

Component

| | Al₂O₃ | MgO | SiO₂ | ZrO₂ | TiO₂ |
|---|---|---|---|---|---|
| Amount | 41.8 | 17.4 | 24.2 | 0.72 | 0.56 |

Also, fire assay results showed that respective contents of platinum and palladium among platinum group metals were 756 ppm and 367.5 ppm.
Commercially available hydrochloric acid (Merck), nitric acid (Riedel-deHa″en), NaOH pellets (Junsei Chemical Co. Ltd.), thiourea (Junsei Chemical Co. Ltd.), thioglycol (Sigma-Aldrich), P-IL (trihexyl(tetradecyl)phosphonium chloride; Cyphos IL101; Cytec Industries Inc., Canada), and aromatic solvent C10 (SOLVENTIS) were used, and no additional purification treatment was performed.

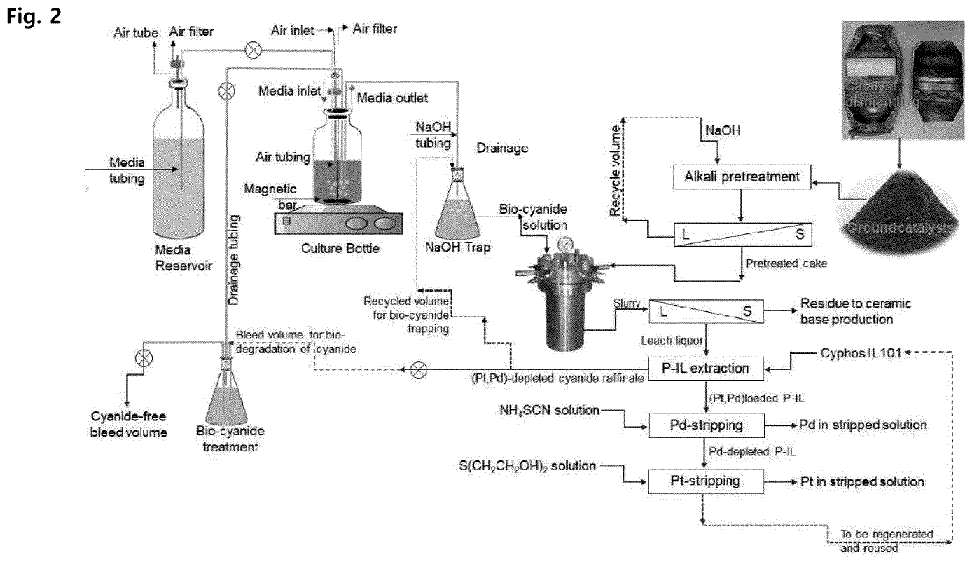

In this example, the platinum group metals were recovered from the spent catalyst by performing the major steps of the process illustrated in FIG. 2.

### Example 1

### Bio-Cyanide Synthesis

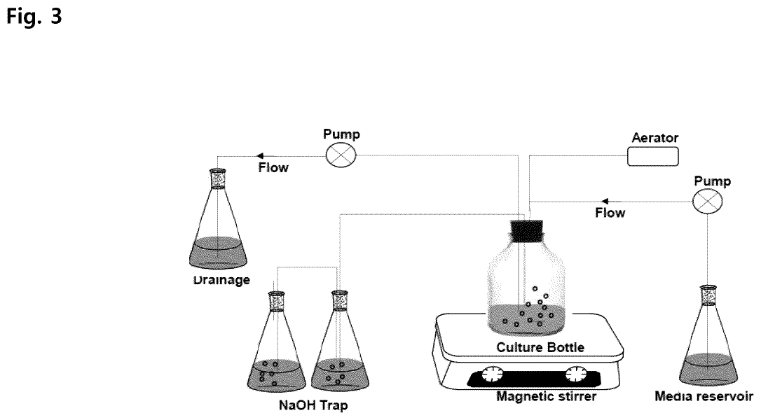

In this example, a bio-cyanide production and concentration (accumulation) experiment was performed using the set-up apparatus shown in FIG. 3.

12 ml (about 10⁶ CFU/ml) of pre-grown cyanide-producing bacteria (C. violaceum DSM30191) was inoculated into YP medium (10 g of peptone, 5 g of yeast extract, and 1.0 L of distilled water) supplemented with 2.0 g/L glycine at 30° C. and pH 8.5. Cyanide synthesis was performed in a bioreactor (equipped with a stirrer to perform stirring at 300 rpm), in which air was supplied constantly at a flow rate of 3.0 ml/s using an aerator. The bioreactor was maintained at 30° C. for 120 hours. In addition, a 4.0 mol/L NaOH solution was used as an alkali collector for concentration (accumulation) of the synthesized bio-cyanide. The concentration of bio-cyanide was assayed by titration against a standard AgNO₃ solution, and cells were counted by the drop plate method on nutrient agar using plates incubated at 30° C. for 24 hours.

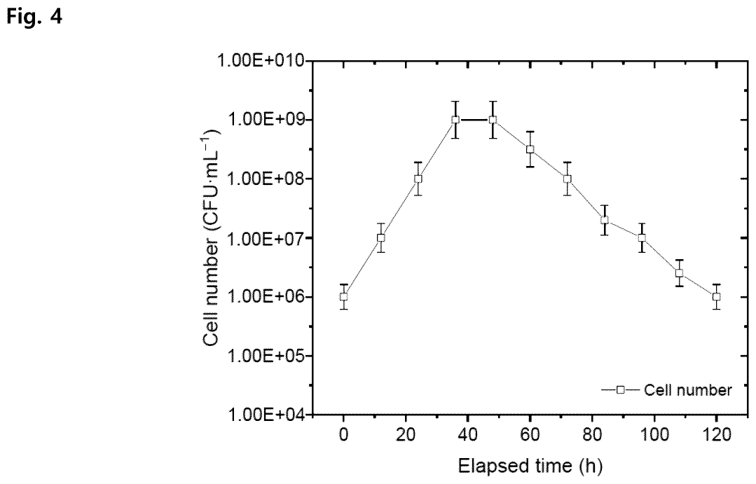

The results of measurement of the C. violaceum cell count in YP medium supplemented with 2.0 g/L glycine over time in the batch mode bio-cyanide production are shown in FIG. 4.

Referring thereto, the cell count increased from 10⁶ CFU/ml to 10⁹ CFU/ml within 36 hours of incubation and was maintained thereafter for up to 12 hours. Then, after 120 hours of incubation, the cell count decreased to 10⁷ CFU/ml.

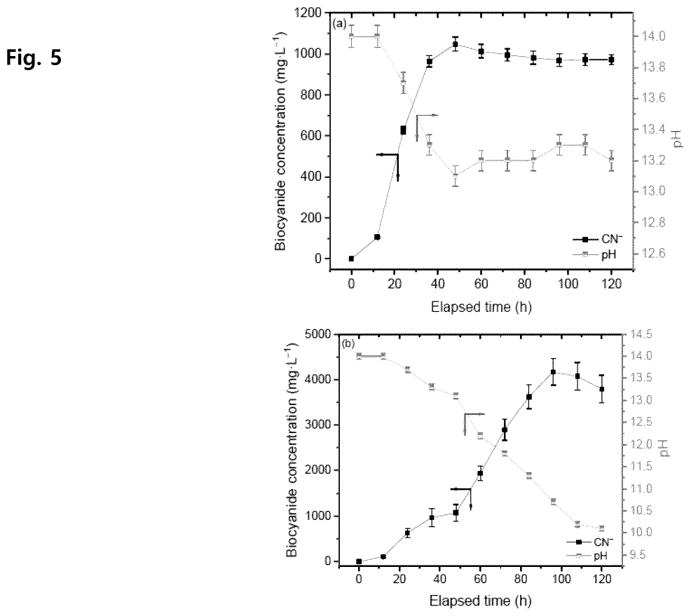

Meanwhile, in each of (a) a batch mode and (b) a continuous mode, the accumulation of biogenic cyanide and the pH change over time when preparing a bio-cyanide solution using YP medium with a glycine concentration of 2.0 g/L and a 4.0 mol/L NaOH trapping solution are shown in FIG. 5.

Referring to FIG. 5a, bio-cyanide accumulation in the alkali solution (NaOH trapping solution) started after 12 hours (10⁶ mg/L CN⁻) and continued over 48 hours, reaching a maximum accumulation of 1.05 g/L CN⁻ and then starting to decrease.

Meanwhile, cyanide (HCN) synthesis was performed by a continuous process that allowed higher concentrations of cyanide ion accumulation under conditions of a retention time of 24 hours using YP medium supplemented with 2.0 g/L glycine. As can be seen in FIG. 5b, the maximum concentration of 4.17 g/L CN⁻ was reached after 96 hours in an alkali collector with a pH of 10.7. Then, the CN⁻ ion concentration decreased to 3.8 g/L after 120 hours, which is supposed to be because some of the CN⁻ ions were converted into HCN due to the pH decreased to about 10 (pKa, 9.3).

### Example 2

### Evaluation of Effect of Temperature on Bioleaching

Bioleaching was performed under pressurized conditions in an autoclave ((Ni—Cr) alloy 600 reactor; 200 ml) using a bio-cyanide solution pre-adjusted to a CN⁻ ion concentration of 2.9 g/L as a lixiviant medium. 20 g of a spent catalyst sample was added to 100 ml of the bio-cyanide solution, and pressurized leaching was performed at a stirring speed of 200 rpm while varying the temperature in the range of 100 to 200° C. (pO₂: 10.5 bar; 1 hour).

Thereafter, the solution was collected by filtration using a 0.45 μm membrane filter, and Pt—Pd analysis was performed on the collected filtrate using ICP-mass spectrometry (ICP-MS; MSS 01, SPECTRO Analytical Instruments GmbH, Germany).

The metal leaching efficiency was calculated according to Mathematical Formula 1 below:

$$Leaching ( \% ) = ( \frac{{M}_{IS} - {M}_{LL}}{{M}_{IS}} ) \times 100 \qquad [ Mathematical Formula 1 ]$$

wherein, M_{IS} and M_{LL} are the metal content in the solid sample and the metal content in the leach liquor, respectively.

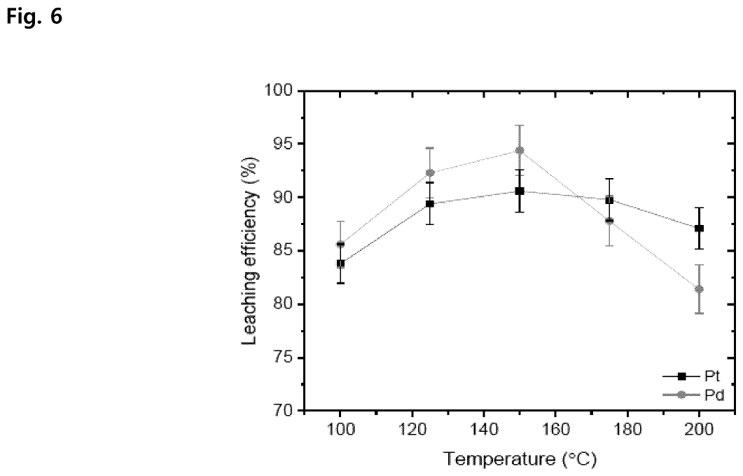

The effect of temperature on the pressurized bio-cyanidation of Pt and Pd is shown in FIG. 6.

Referring to the figure, the leaching efficiencies of Pt and Pd in the cyanide-containing solution at a high temperature of 100° C. were determined to be 85% or less. However, at 150° C., the leaching efficiencies reached a maximum of 91% Pt and 94% Pd. Thereafter, the leaching efficiencies decreased with an increase in the temperature, reaching a maximum of 87% Pt and 81% Pd at 250° C. This decreasing behavior is supposed to be due to the decomposition of cyanide at higher temperatures owing to an increase in the hydrolysis rate, as represented in Schemes 2 and 3 below.

CN⁻+2H₂O→HCOO⁻+NH₃ Scheme 2

CN⁻+2H₂O→HCN+OH ⁻ Scheme 3

### Example 3

### Evaluation of Effect of Partial Oxygen Pressure on Bioleaching

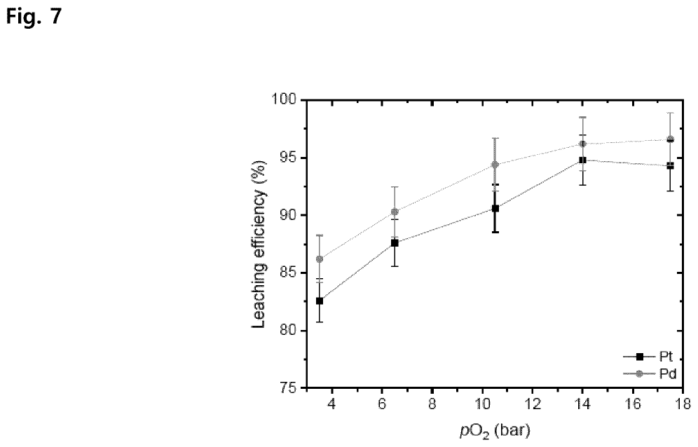

A bioleaching experiment was performed according to the experimental procedure of Example 2 (temperature of 150° C., CN⁻ concentration of 2.9 g/L, initial pH of 11.2, and 60 minutes), with the exception that bioleaching was performed while varying the partial oxygen pressure (pO₂) in the range of 3.5 to 17.5 bar. The results thereof are shown in FIG. 7.

Referring to the figure, the leaching of platinum group metals (Pt and Pd) greatly increased with an increase in pO₂ and reached 94% or more at pO₂ of 17.5 bar. The catalytic role of oxygen in cyanide can be confirmed by the behavior through cyanidation according to Schemes 4 and 5 below.

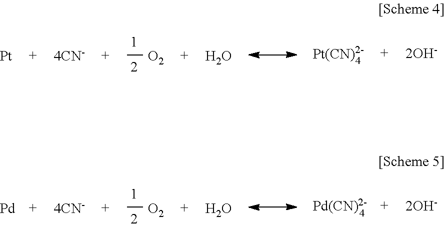

### Example 4

### Evaluation of Effect of Bio-Cyanide Concentration on Bioleaching

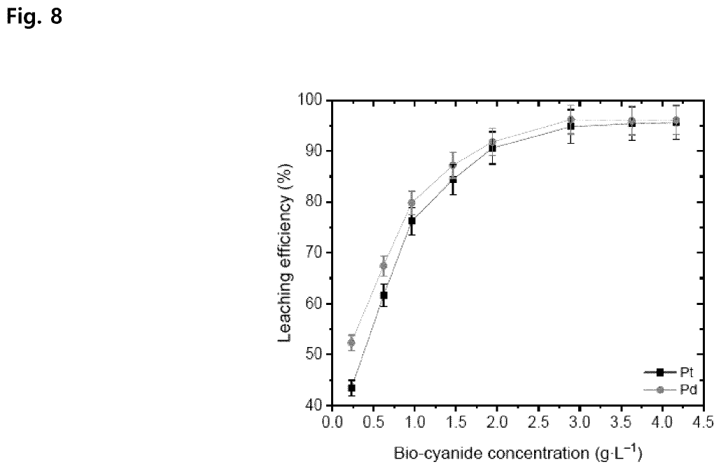

A bioleaching experiment was performed according to the experimental procedure of Example 2 (temperature of 150° C., pO₂ of 14 bar, initial pH of 11.2, and 60 minutes), with the exception that bioleaching was performed while varying the concentration of bio-cyanide (CN⁻) in the range of 0.23 to 4.17 g/L. The results thereof are shown in FIG. 8.

Referring to the figure, as the CN⁻ concentration increased, the Pt leaching efficiency (from 43% to >95%) and Pd leaching efficiency (from 52% to 96%) also increased. Moreover, the residual cyanide concentration increased from 0.032 g/L to >1.0 g/L. In particular, the maximum leaching efficiency was observed in the cyanide-containing solution with 2.9 g/L CN⁻. The stock leach liquor (Pt, 157.5 mg/L and Pd, 77.6 mg/L) was used in the subsequent separation (liquid-liquid extraction) process.

### Example 5

Evaluation of Effect of Extractant Concentration on Extraction of Platinum Group Metals from Platinum Group Metal-Containing Cyanide Leach Liquor

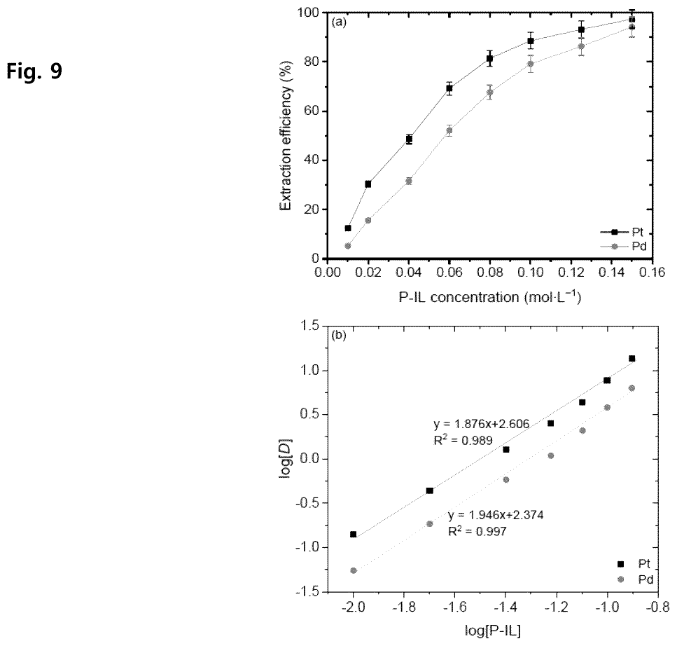

Trihexyl(tetradecyl)phosphonium chloride, a phosphonium-based ionic liquid, was dissolved in an aromatic solvent (C10), and platinum group metals (Pt and Pd) in a cyanide leach liquor (pH 10.8) were extracted while varying the concentration of the ionic liquid in the range of 0.01 to 0.15 mol/L. As such, the organic to aqueous phase ratio (O:A) was 1, and contact was made at 25° C. for 10 minutes. The results thereof are shown in FIG. 9.

Referring to FIG. 9a, as the number of active molecules of the ionic liquid in the organic phase increased, the extraction efficiencies of Pt and Pd increased, reaching 97% Pt and 94% Pd at 0.15 mol/L of ionic liquid.

Referring to FIG. 9b, the log distributions Pt and Pd showed a linear relationship with log [P-IL] and a slope value of about 2. As such, the slope value indicates that 2 molecules of ionic liquid are involved per mole of Pt and Pd extraction complexes. Based on this relationship, extraction may be represented by Schemes 6 and 7 below.

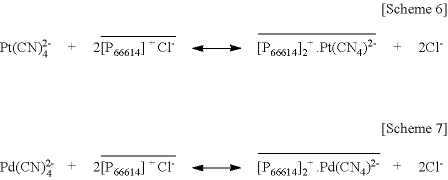

### Example 6

Evaluation of Effect of pH on Extraction of Platinum Group Metals from Platinum Group Metal-Containing Cyanide Leach Liquor

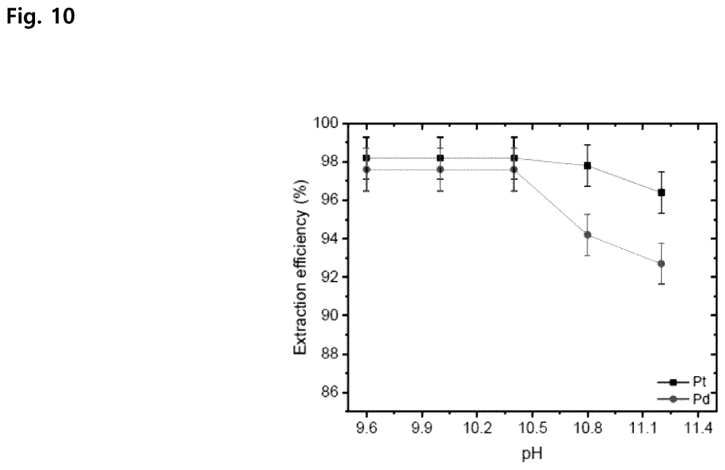

An extraction experiment was performed according to the experimental procedure of Example 5 (O:A, 1; P-IL concentration, 0.15 mol/L; contact time, 10 minutes; and temperature, 25° C.), with the exception that liquid-liquid extraction was performed while varying the pH of the platinum group metal-containing solution (leach liquor) in the range of 10.4 to 11.2. The results thereof are shown in FIG. 10. As such, the extraction efficiency was calculated according to Mathematical Formula 2 below:

$$Extraction ( \% ) = [ \frac{D \times ( \frac{{V}_{org}}{{V}_{aq}} )}{D \times ( \frac{{V}_{org}}{{V}_{aq}} ) + 1} ] \times 100 \qquad [ Mathematical Formula 2 ]$$

wherein, V_{org} and V_{aq} are the volumes of the organic phase and the aqueous phase, respectively.

Referring to the figure, the extraction of Pt and Pd tended to increase with a decrease in the pH of the leach liquor from 11.2 (96.4% Pt and 92.7% Pd) to 10.4 (98.2% Pt and 97.6% Pd). Thus, the reason for the low extraction efficiency at high pH is supposed to be because hydroxide ions are competitively extracted. To prevent the toxicity of HCN formed at low pH (HCN:CN⁻=1:1 (pKa 9.3)), extraction at pH 10.4 was found to be optimal, which was applied to subsequent experiments.

### Example 7

Evaluation of Effect of Temperature on Extraction of Platinum Group Metals from Platinum Group Metal-Containing Cyanide Leach Liquor

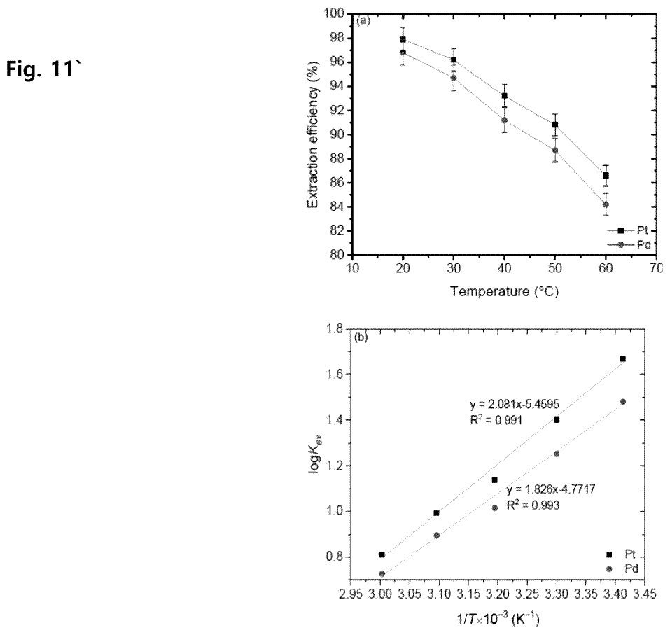

An extraction experiment was performed according to the experimental procedure of Example 5 (O:A, 1; P-IL concentration, 0.15 mol/L; solution pH, 10.4; and contact time, 10 minutes), with the exception that liquid-liquid extraction was performed while varying the extraction temperature in the range of 20 to 60° C. The results thereof are shown in FIG. 11.

Referring to FIG. 11a, the extraction efficiency decreased with an increase in the temperature (Pt: from 98% to <87%; Pd: from 97% to 86%). These results indicate that the reaction was exothermic and that the metal-binding ability of the ionic liquid decreased with an increase in the temperature.

Referring to FIG. 11b, a straight line was obtained with a regression coefficient value exceeding 0.99, and using the slope value of the straight line, apparent enthalpy changes (ΔH°) for Pt and Pd extraction were measured to be ΔH° (Pt), −39.8 kJ/mol, and ΔH° (Pd), −34.9 kJ/mol. Based on the above results, exothermic characteristics of the metal-ion complex can be confirmed.

### Example 8

Stripping of Pd from Pt—Pd Loaded Ionic Liquid

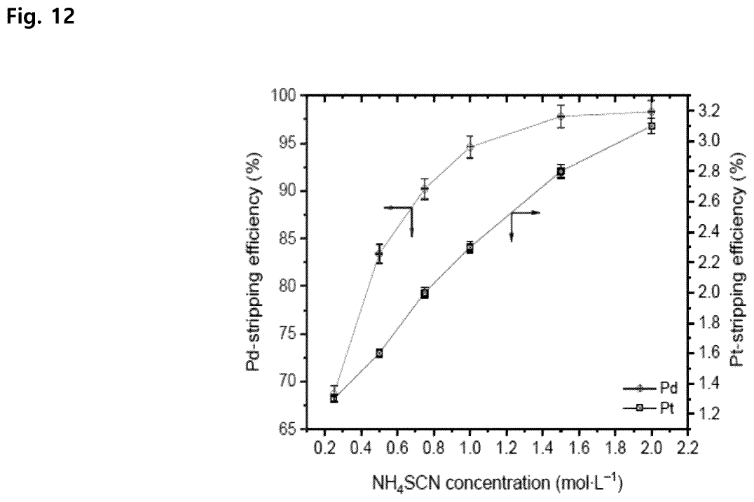

The Pt—Pd loaded ionic liquid was brought into contact with an aqueous NH₄SCN solution at various concentrations (0.25 to 2.0 mol/L) (O:A, 1; contact time, 10 minutes; and temperature, 25° C.). The results thereof are shown in FIG. 12. As such, the stripping efficiency was calculated according to Mathematical Formula 3 below:

$$Stripping ( \% ) = [ \frac{{CS}_{aq} \times {V}_{aq}}{{CS}_{org} \times {V}_{org}} \times 100 ] \qquad [ Mathematical Formula 3 ]$$

wherein, CS_{org} and CS_{aq} are the metal concentrations after stripping in the organic phase and the aqueous phase, respectively.

In the above drawing, the NH₄SCN solution showed the selective recovery of Pd over Pt. Specifically, as the concentration of NH₄SCN increased from 0.25 mol/L to 1.0 mol/L, the Pd stripping efficiency greatly increased from 68% to >94%. Thereafter, stripping hardly progressed, showing stripping efficiency of 98% or more in a 2.0 mol/L NH₄SCN solution, and as such, Pt was less than 3%.

In this regard, selectivity achieved in thiocyanate stripping is supposed to be due to the larger size of Pt(CN)₄²⁻ than Pd(CN)₄²⁻, resulting in a higher charge density of the Pd compound. The reaction involved in Pd stripping using the NH₄SCN solution may be represented by Scheme 8 below.

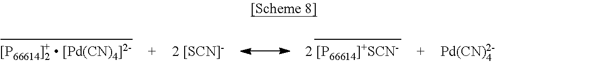

### Example 9

Stripping of Pt from Pd-Depleted Ionic Liquid

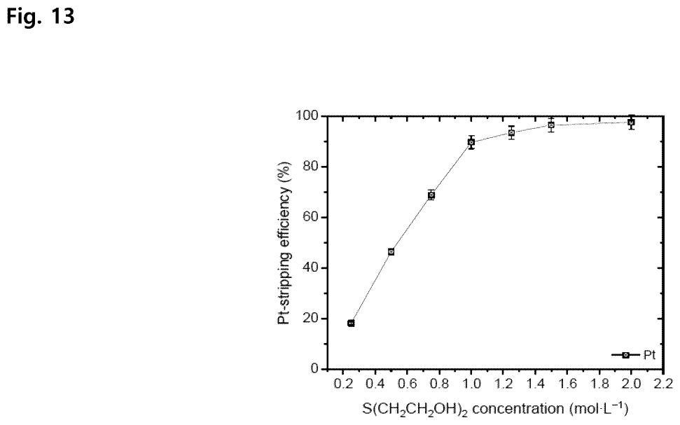

The Pd-depleted ionic liquid was brought into contact with an aqueous S(CH₂CH₂OH) 2 solution at various concentrations (0.25 to 2.0 mol/L) (O:A, 1; contact time, 10 minutes; and temperature, 25° C.). The results thereof are shown in FIG. 13.

Referring to the figure, the Pt stripping efficiency reached about 90% in a 1.0 mol/L S(CH₂CH₂OH) 2 solution and about 96% in a 1.5 mol/L S(CH₂CH₂OH) 2 solution. However, even when the concentration of S(CH₂CH₂OH) 2 was further increased, no significant increase in the stripping efficiency was observed. In this regard, coordination substitution reaction of Pt stripping using S(CH₂CH₂OH) 2 may be represented by Scheme 9 below.

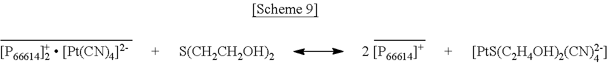

### Example 10

### Evaluation of Recyclability of Cyanide-Containing Raffinate and Reusability of Organophosphorus Ionic Liquid

The recyclability of cyanide remaining in the raffinate formed after extracting platinum group metals (Pt and Pd) from a bio-leach liquor using an organophosphorus ionic liquid (trihexyl(tetradecyl)phosphonium chloride) as an extractant was evaluated.

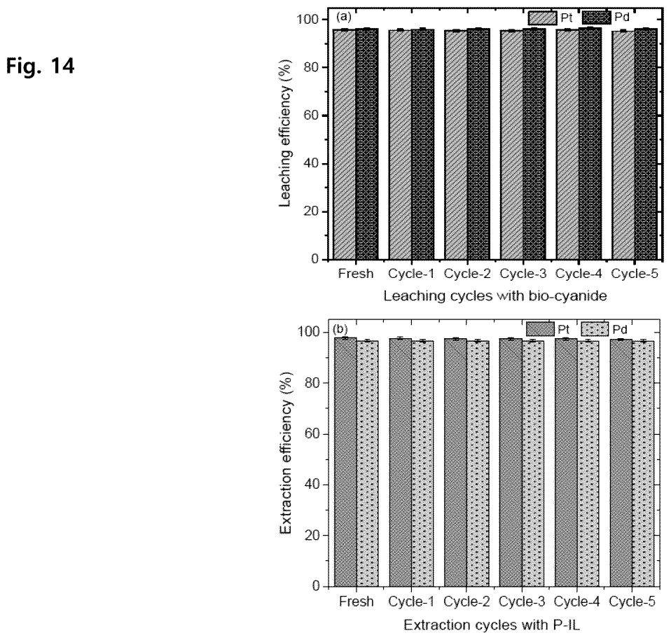

Specifically, as shown in FIG. 2, the raffinate containing 3.8×10⁻⁸ μmol/L CN⁻ was recycled into an alkali collector to adjust the concentration with 4.0 mol/L NaOH, and then the bio-cyanide was concentrated (accumulated). Five consecutive leaching experiments were performed using the concentrated bio-cyanide under optimized leaching conditions (temperature, 150° C.; pO₂, 14 bar; CN⁻ concentration, 2.9 g/L). The results thereof are shown in FIG. 14a.

Referring to the figure, the leaching efficiencies of Pt and Pd were both about 95%, confirming recyclability of the residual cyanide solution.

Meanwhile, reusability of the organophosphorus ionic liquid used in the extraction process was evaluated by bringing the same into contact with a 6.0 mol/L HCl solution for 30 minutes to separate the ionic liquid and the acid solution followed by regeneration of the organic phase. As such, two platinum group metals were individually separated by repeatedly performing the extraction, stripping, and regeneration cycles. The results thereof are shown in FIG. 14b.

Referring to the figure, the extraction efficiencies of Pt and Pd were both >97% based on the results for a total of five consecutive cycles. This means that the ionic liquid is stable and also exhibits good regeneration and reusability, supporting sustainability of the process proposed in FIG. 2.

### Example 11

### Evaluation of Biodegradability of Recycled Cyanide-Containing Raffinate

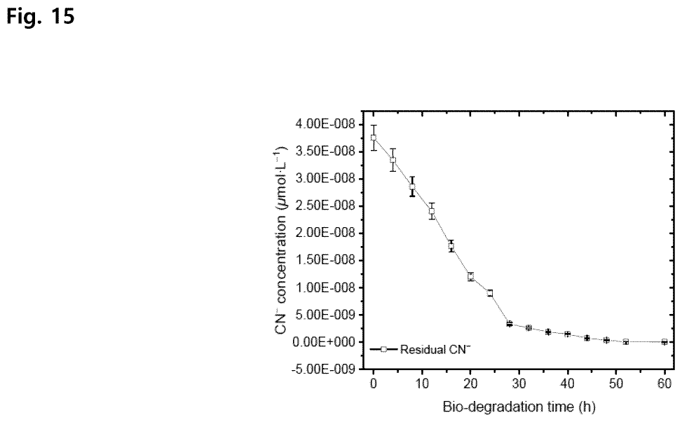

After five sequential leaching-extraction-stripping cycles, biodegradability of residual cyanide was evaluated by bleeding out 25% of the cyanide-containing raffinate volume. The results thereof are shown in FIG. 15.

Referring to the figure, significant decomposition of the residual cyanide began as soon as 8 hours after contact with drained C. violaceum, and exceeded 90% after 28 hours. Maximum detoxification (>99%) of CN⁻ ions was achieved after 60 hours. The final concentration of CN⁻ ions was 5.64×10⁻¹¹ μmol/L (the initial concentration in the bleed solution was 3.76×10⁻⁸ μmol/L).

Therefore, it can be found that residual cyanide is capable of being decomposed by the microorganism (enzyme) previously used for bio-cyanide production, and being discharged with reduced toxicity after the decomposition process.

Simple modifications or changes of the present disclosure may be easily used by those skilled in the art, and all such modifications or changes may be considered to be included in the scope of the present disclosure.

1. A method of recovering a platinum group metal from a spent catalyst, comprising:
a) forming a platinum group metal-containing cyanide leach liquor by leaching platinum group metals from a platinum group metal-containing spent catalyst using a solution containing bio-cyanide produced by metabolic action of a cyanide-producing microorganism;
b) forming a platinum group metal-rich extract and a platinum group metal-depleted raffinate by liquid-liquid extraction treatment of the platinum group metal-containing cyanide leach liquor using a water immiscible organophosphorus ionic liquid as an extractant; and
c) recovering platinum group metals from the extract.

2. The method of claim 1, wherein the platinum group metal-containing spent catalyst contains at least one platinum group metal selected from the group consisting of platinum and palladium.

3. The method of claim 2, wherein the platinum group metal-containing spent catalyst does not contain rhodium.

4. The method of claim 1, wherein the platinum group metal-containing spent catalyst is provided in step a) in the form of particles or ground material having a particle size of 350 μm or less.

5. The method of claim 1, wherein a total content of platinum group metals in the platinum group metal-containing spent catalyst is 0.005 to 0.4 wt %.

6. The method of claim 5, wherein the platinum group metal-containing spent catalyst contains platinum and palladium, and respective contents of platinum and palladium are 0.003 to 0.15 wt % and 0.002 to 0.1 wt %.

7. The method of claim 1, further comprising pretreating the platinum group metal-containing spent catalyst with an alkali-containing solution comprising at least one selected from the group consisting of sodium hydroxide, potassium hydroxide, and ammonium hydroxide, before step a).

8. The method of claim 1, wherein the cyanide-producing microorganism is at least one selected from among classes belonging to betaproteobacteria and gammaproteobacteria.

9. The method of claim 1, wherein a pH of an aqueous solution containing bio-cyanide in step a) is in a range of 9.5 to 14, and a concentration of cyanide (CN) is in a range of 2 to 6 g/L.

10. The method of claim 1, further comprising concentrating or accumulating the solution containing bio-cyanide by being trapped or collected into an alkali solution, before leaching the platinum group metals in step a).

11. The method of claim 1, wherein the leaching is performed at a temperature of 100 to 200° C. under an oxygen pressure of at least 8 bar.

12. The method of claim 1, wherein a pH of the platinum group metal-containing cyanide leach liquor formed in step a) is in a range of 9 to 12.5.

13. The method of claim 1, wherein the water immiscible organophosphorus ionic liquid used in step b) comprises a phosphonium-based cation group represented by General Formula 1 below, and an anion group selected from the group consisting of a halide, a sulfide, and a nitrate: 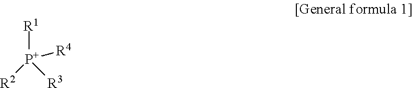
wherein R¹ to R⁴ are each an alkyl group having 35 to 56 carbon atoms.

14. The method of claim 13, wherein a molecular weight (M_{w}) of the organophosphorus ionic liquid used in step b) is in a range of 200 to 900.

15. The method of claim 2, wherein step c) is performed by stripping.

16. The method of claim 15, wherein at least one stripping agent selected from among thiocyanate compounds is used to recover palladium from the extract, and at least one stripping agent selected from among thioalcohols is used to recover platinum from the extract.

17. The method of claim 10, further comprising recycling the platinum group metal-depleted raffinate into the solution containing bio-cyanide and/or the concentrated or accumulated solution containing bio-cyanide in step a).

18. The method of claim 1, further comprising decomposing cyanide in the platinum group metal-depleted raffinate by the cyanide-producing microorganism.

19. The method of claim 1, further comprising separating the organophosphorus ionic liquid from the extract remaining after recovery of the platinum group metals in step c) and reusing the organophosphorus ionic liquid as an extractant in step b).
